(19) United States
(12) Patent Application Publication
(10) Pub. No.: US 2006/0212340 A1
(43) Pub. Date: Sep. 21, 2006

(54) Method and apparatus for product management

(76) Inventors: Juile W. Drew, Redwood City, CA (US); Qi Feng, Richardson, TX (US); Bin Zhang, Freemont, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/083,576

(22) Filed: Mar. 18, 2005

(51) Int. Cl. G07G 1/00

(52) U.S. Cl. 705/10

(57) ABSTRACT

A method for selecting products for a product portfolio includes identifying a set of customer orders including a set of ordered products, a total order benefit and a penalty multiplier and identifying one or more subsets of the ordered products each having a subset order benefit and a penalty multiplier. The method also includes selecting one or more of the penalty multipliers using a binary search in order to generate a series of solutions along an efficient frontier of order benefit coverage versus number of ordered products selected An apparatus for product portfolio selection is also described.

### BACKGROUND

Product proliferation is a concern for many business enterprises because making or selling numerous products adds to inventory and management costs. Further, a business enterprise can lose sales as a result of consumer confusion stemming from numerous product choices. In today's fast paced business climate, businesses attempt to monitor the financial success of the products that are offered for sale. Businesses strive to select a particular product portfolio for sale to customers that increase the business' profit.

### BRIEF DESCRIPTION OF THE DRAWINGS

FIG. 1 shows a graphical representation of LR(λ) in accordance with an embodiment of the invention;

FIG. 2 shows an action taken during a binary search in accordance with an embodiment of the invention;

FIG. 3 shows another action taken during the binary search in accordance with an embodiment of the invention;

FIG. 4 shows still another action taken during the binary search in accordance with an embodiment of the invention;

FIG. 5 shows a flowchart of a binary search in accordance with an embodiment of the invention; and

FIG. 6 shows a block diagram of an apparatus in accordance with an embodiment of the invention.

### NOTATION AND NOMENCLATURE

Certain term(s) are used throughout the following description and claims to refer to particular system components. As one skilled in the art will appreciate, different companies/industries may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

In accordance with various embodiment of the invention, methods and apparatuses are described that reduce the number of products included in a product portfolio to a set of products that is expected to cover most, or at least a substantial amount of order revenue, profit or number of orders covered. The disclosed approach helps reduce the costs associated with managing a product offering without substantially sacrificing the variety that customers desire and the associated revenue from customer demand.

As an illustrative example, in the personal computer (PC) business, a customer's order comprises a particular set of products such as a chassis, processor, memory card, graphics card, monitor, mouse, keyboard and power cable. In one embodiment, an order is said to be “covered” by a product set if every product in the order is included in the set. A method is described for selecting a set of at most n products to offer for sale to maximize the revenue of orders that are covered by the product set for a range of product sets of different sizes.

To better describe embodiments of the invention, some mathematical notation is first presented. Because it is desirable to find a set of products of a size of at most “n” that maximizes the revenue of orders covered, as a first step, the problem can be formulated as an integer program model (denoted by IP(n)) by defining decision variables, constraints and an objective function as follows for IP(n):

Decision Variables

Let Xₚ=1 if product “p” is included in the product portfolio, otherwise Xₚ=0.
Let Yₒ=1 if order “o” is covered by the portfolio, otherwise Yₒ=0. Constraints
Order o is not covered unless each product p in the order is included:
Yₒ≦Xₚ for each product-order combination (o,p).
At most n products are included: ΣₚXₚ≦n.
X and Y variables are binary: Xₚε{0,1}, Yₒε{0,1}.
   Objective Function
Maximize the total revenue of orders covered by the product portfolio: Σₒ RₒYₒ.
Rₒ=revenue, profit, 1 (setting Rₒ equal to 1 means that selecting the portfolio of a certain size to maximize the number of orders covered) for each order o.

X and Y comprise vectors that represent products and orders respectively. The third constraint, which requires the Xₚ, Yₒ variables to have binary values (e.g., 0 and 1),can make the integer programming model problem mathematically intensive.

In accordance with an embodiment of the invention, the requirement that the Xₚ,Yₒ variables comprise binary values is relaxed, and is replaced with a requirement that permits Xₚ,Yₒ to be continuous variables with values in a particular range such as in the interval of 0 to 1. This latter requirement in which Xₚ,Yₒ comprise values in a particular range transforms the problem into a linear program which can be solved faster than the integer program model above. Secondly, the constraint that ΣₚXₚ≦n is eliminated and is replaced with a penalty term in the objective, -λΣₚ Xₚ. The number of products used in the solution is penalized by a nonnegative number λ, the solution will be referred to as the Langrangian Relaxation, LR(λ) or linear programming relaxation of IP(n).

Some notation used for LR(λ) include:

Decision Variables

Xₚ
Yₒ
   Constraints
Order o is not covered unless each product p in the order is included:
Yₒ≦Xₚ for each product-order combination (o,p).
X and Y variables are between the continuous values of zero and one: 0≦Xₚ≦1 and 0≦Yₒ≦1.
   Objective Function
Maximize the total revenue of orders covered: Σₒ RₒYₒ−λ(Σₚ Xₚ−n), or equivalently, since −λn is a constant, maximize the total revenue of orders covered minus λ times the number of products included in the product portfolio which is a penalty term: Σₒ RₒYₒ−λ ΣₚXₚ.
Rₒ=revenue, profit, 1 (setting Rₒ equal to 1 means that selecting the portfolio of a certain size to maximize the number of orders covered) for each order o.

By solving LR(λ) for a properly chosen series of values of λ (λ is also referred to as a penalty multiplier), a series of solutions to IP(n) for several values of n can be obtained. Solving for LR(λ) can not yield solutions for IP(n) for all values of n, however, obtaining the solution to IP(n) for some values of n can help provide a series of solutions along a graph of revenue coverage versus product portfolio size. Although this series of solutions does not provide an integer solution for every value of n, in practice, if the values of the penalty multiplier λ are chosen carefully, a dense curve of solutions can be found which can be used to make product portfolio decisions.

The problem LR(λ) can be solved using a linear programming algorithm. However, for very large problems, each problem takes several minutes to solve. To solve the problem for many values of λ, in order to generate a dense plot of revenue coverage versus product portfolio size, can take hours. Therefore, in one embodiment of the invention, a method of selecting a minimal set of values of λ in order to generate a maximally-dense graph of revenue coverage versus portfolio size is described.

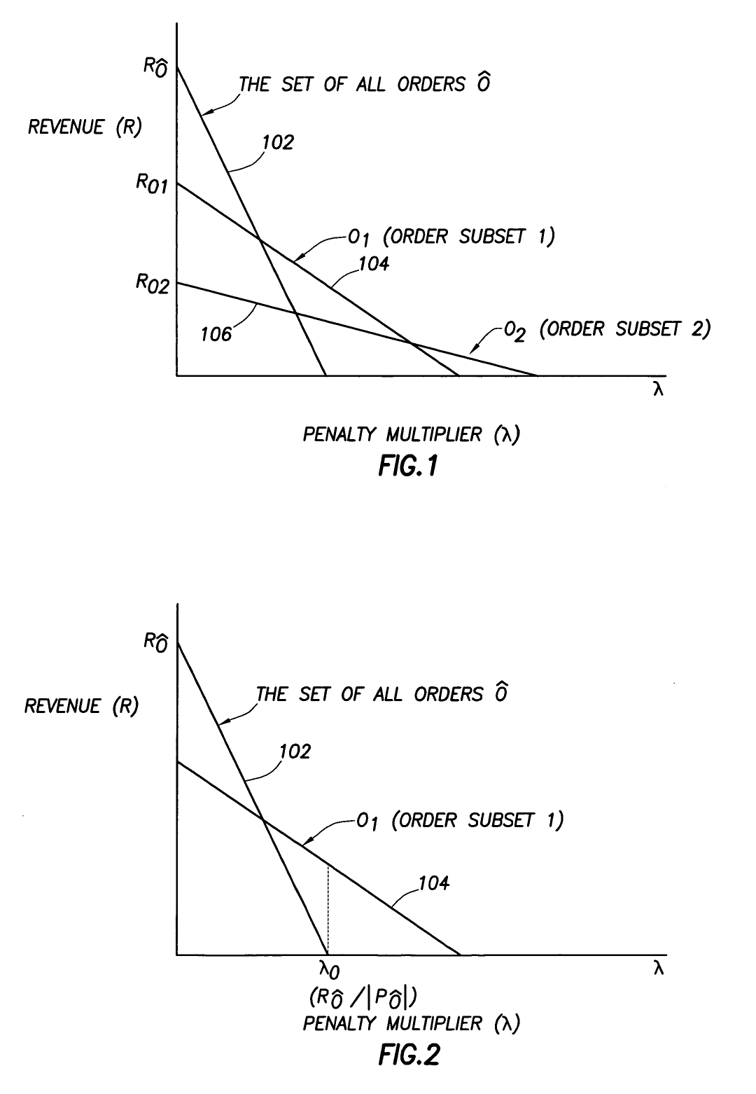

Solving LR(λ) has a graphical interpretation, it is equivalent to finding the upper envelope of a set of linear functions of λ. For each subset O of orders, there is a linear function f_{O} (λ)=R_{O}−λ|P_{O}|, where P_{O} is the set of products in all orders in O. Solving LR(λ) is equivalent to finding which order subset has the largest value of f_{O}(λ). This problem can be represented as shown in FIG. 1. As λ increases, the order subset at which the maximum is achieved changes. For small values of lambda (λ), the entire set of orders, Ô, has the highest linear function. As λ increases, O₁ yields the highest line, and O₂ takes over at the intersection of O₁ and O₂. The upper envelope includes line segments 102, 104 and 106 which are portions of the graph lines Ô, O₁ and O₂. For sufficiently large λ, the empty order subset gives the maximum line.

For large sized problems there are too many order subsets to consider so actually drawing a graph as shown in FIG. 1 is not feasible. A graph can be used to provide useful information, and to help identify which specific values of λ are needed to solve LR(λ). The goal is to find the order subset corresponding to each line segment that is part of the upper envelope. To do so, a set of values of λ have to be found that generate each different line segment, and solves the problem LR(λ) for those values. Finding the order subset corresponding to each line segment can be accomplished without plotting the functions f_{O}(λ) for each order subset O.

The first action is to consider the entire set of orders Ô, and find the value of λ at which the corresponding line R_{Ô}−λ|P_{Ô}| intersects the λ-axis. The value is determined by λo which is equal to R_{ô}/|P_{Ô}|. The second action is to solve the problem LR(λo). There are two possible scenarios in solving LR(λo): (a) If the solution to LR(λo) yields the entire set of orders Ô as a solution, then the line for every order subset lies beneath the line for Ô, and the solution to LR(λ) is the same for all values of λ. (b) If the order subset O₁ which solves LR(λo) is different from the entire set of orders, then its line f_{O1}(λ) lies above the corresponding line for Ô at λo, this case is shown in FIG. 2.

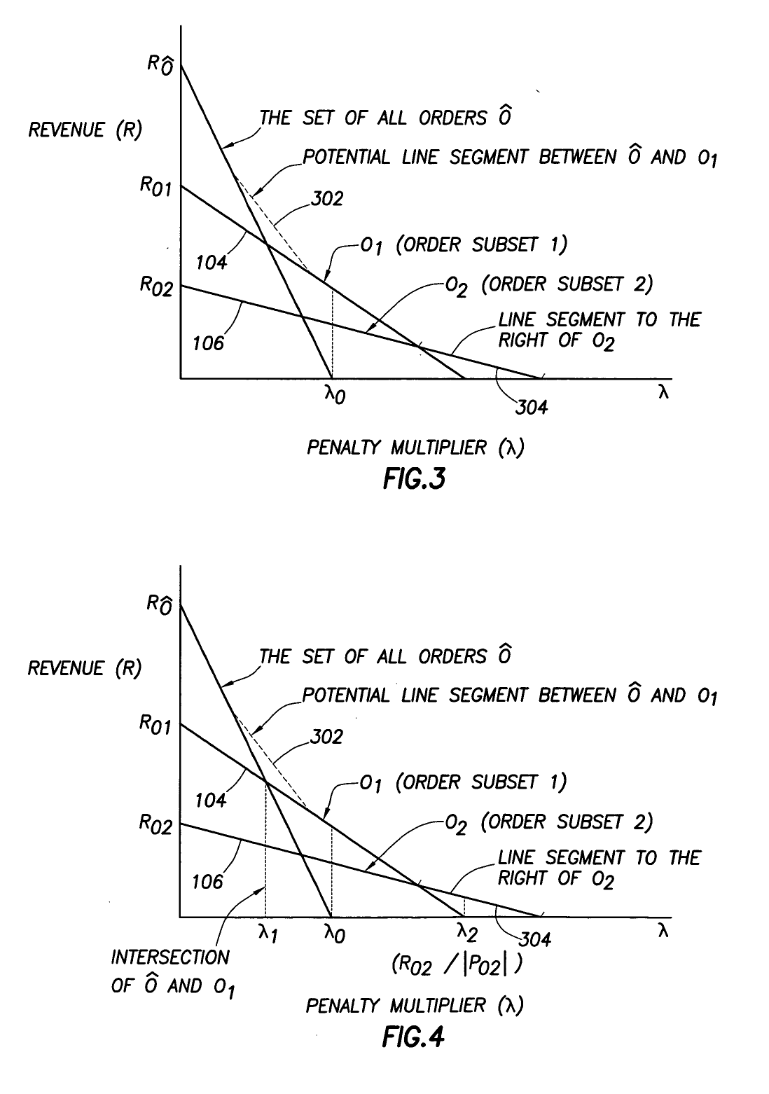

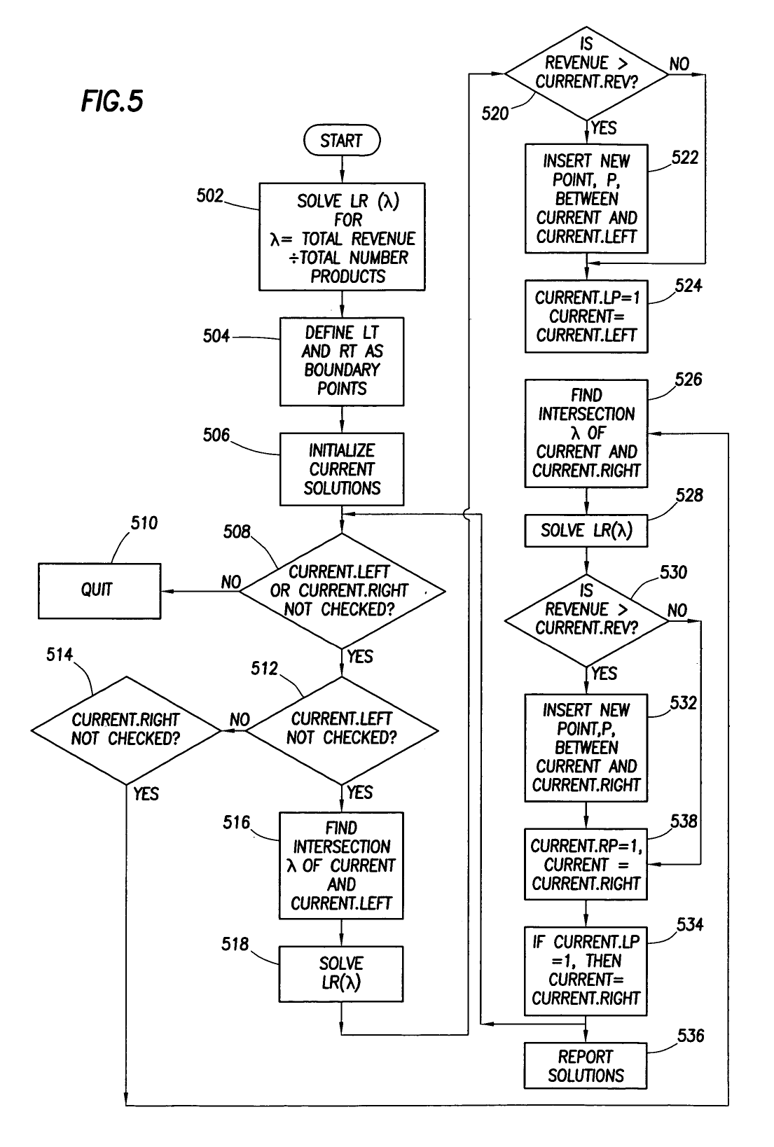

If scenario (b) above holds true, then in order to find all line segments along the upper envelope, it is determined if there is another line segment to the right of the line O₁, which in the illustrative example shown in FIG. 3, is shown as line segment 304. Also it needs to be determined if there is another line segment between those for Ô and O₁, which is shown as line segment 302 in this example. In order to determine whether there is another line segment located between Ô and O₁ the intersection point of Ô and O₁ is determined. This point is labeled λ₁ in FIG. 4 and λ₁ is equal to (R_{Ô}−R_{O1})/(|P_{Ô}|−(|P_{O1}).

Solving for LR(λ₁) again, two possible cases can be achieved:
(a) The objective value at LR(λ₁) equals f_{Ô}(λ₁) which equals f_{O1}(λ₁), in which case there is no new line segment between Ô and O₁, dashed line 302 would not exist in this particular example.
(b) The objective value at LR(λ₁) is greater than f_{Ô}(λ₁) which equals f_{O1}(λ₁), in which case there is a new line segment between Ô and O₁, similar to line segment 302.

In order to determine if there is another line segment to the right of the line for O₁, as shown for example by line 304 in FIG. 4, the point λ₂ at which line O₁ intersects the λ-axis is located. Just as it was done for λ₁, solving for LR(λ₂) tells us if there is a line segment to the right of the segment for O₁.

Although some of the actions taken during the binary search method have been described above, pseudo code for the entire method is shown below. A data structure for each of the solutions generated is also defined. The method obtains a linked list of optimal solutions, with the left most solution being labeled as LT, and the right most solution being labeled as RT. It should be noted that based on specific system design requirements, the binary search algorithm shown below can be modified.

Illustrative Pseudo Code of Product Portfolio Selection Method

struct Lam
{
double value; the value of lambda
double rev; the covered revenue in the solution
double pn; the number of products selected in the solution
int lp; =1 if left side has been checked; 0 otherwise
int rp; =1 if the right side has been checked; 0 otherwise
Lam * left; point to the left side
Lam * right;
};

! The pointer CURRENT is kept as the one currently in process.
BinarySearch( )
Begin
1.0 Initialize:
1.1 Solve LR(Total Revenue/Total Number of Products). Denote solution by S
1.2 Define the two boundary solutions LT and RT: LT is the solution with all products, and RT is the solution with no products. Both LT and RT have lp=rp=1.
1.3 Assign value to CURRENT as
CURRENT.value=Total Revenue/Total Number of Products,
CURRENT.rev=Revenue of S,
CURRENT.pn=Number of products in S
CURRENT.lp=CURRENT.rp=0,
CURRENT.left=LT,
CURRENT.right=RT.
2.0 While CURRENT.lp=0 or CURRENT.rp=0. If CURRENT.lp=0, go to 2.1, else go to 2.2
2.1 Find the intersection of CURRENT and CURRENT.left as lambda=(CURRENT.rev−CURRENT.left.rev) / (CURRENT.pn−CURRENT.left.pn).
2.11 Solve LR(lambda). Denote solution by S.
2.12 If Revenue of S is not the same as CURRENT.rev or CURRENT.left.rev, go to step 2.121; else go to step 2.13.
2.121 Insert a new point inbetween CURRENTand CURRENT.left. Define a new Lam named p with p.rev=Revenue of S, p.value=lambda, p.pn=Number of Products in S, p.rp=0, p.lp=0, p.left=CURRENT.left, p.right=CURRENT. Also move CURRENT.left.right=p and CURRENT.left=p.
2.13 CURRENT.lp=1. CURRENT=CURRENT.left.
2.2 Find the intersection of CURRENT and CURRENT.right as lambda=(CURRENT.rev−CURRENT.right.rev)/(CURRENT.pn−CURRENT.right.pn).
2.21 Solve LR(lambda). Denote solution by S.
2.22 If Revenue of S is not the same as CURRENT.rev or CURRENT.right.rev, go to step 2.221; else go to step 2.23.
2.221 Insert a new point inbetween CURRENT and CURRENT.right. Define a new Lam named p with p.rev=Revenue of S, p.value=lambda, p.pn=Number of products in S, p.rp=0, p.lp=0, p.right=CURRENT.right, p.left=CURRENT. Also move CURRENT.right.left=p and CURRENT.right=p.
2.23 CURRENT.rp=1. CURRENT=CURRENT.right.
2.3 If CURRENT.lp=1, then CURRENT=CURRENT.right.
2.4 Go to step 2.0
   End

Referring now to FIG. 5, there is shown a flowchart of a binary search method in accordance with an embodiment of the invention. The method takes as an input historical order data including the product(s) contained in each of the orders as well as the revenue data for the historical orders. The output of the binary search method can be a graph of revenue coverage versus portfolio size and a nested series of product portfolios corresponding to the points along the graph. Using the binary search output a product portfolio best suited for a desired revenue level can be selected. The method described performs the actions previously described above, primarily the pseudo code shown in Table 1. Although in the embodiment discussed maximization of revenue was the objective function, in other embodiments, the objective function can be maximization of profit, choosing a product portfolio to maximize the number of orders covered, or another similar goal.

In 502, LR(λ) where λ is equal to total revenue divided by the total number of products in the portfolio. In 504, LT and RT are defined as boundary points (also referred to as first and second boundaries) as is done in the pseudo code in step 1.2, while in 506 the process is initialized. In 508, it is determined if CURRENT.left or CURRENT.right have not been checked. If CURRENT.left and CURRENT.right variables have been checked, the routine stops in 510, otherwise the routine moves to 512 where it is determined if CURRENT.left has not been checked. If CURRENT.left has not been checked, in 516 the intersection of A of CURRENT and CURRENT.left is found and in 518, the solution to LR(λ) is determined. If in 512 it is determined that CURRENT.left has been checked, the method moves to decision step 514 in order to determine if Current.right has been checked. The method proceeds to 526 which will be described shortly.

From 518, the method moves to 520 where it is determined if the revenue objective is larger than CURRENT.rev. If it is, in 522 a new point, p, is inserted between CURRENT and CURRENT.left as in step 2.121 of the pseudo code. In 524, CURRENT.lp is set equal to 1 and CURRENT is set equal to CURRENT.left. In 526, the intersection, λ, of CURRENT and CURRENT.right is determined, while in 528, LR (λ) is solved for. In decision block 530 it is again determined if the current revenue is greater than CURRENT.rev, if it is, in 532 a new point, p, is inserted between CURRENT and CURRENT.right as in step 2.221 of the pseudo code, and in 538 then CURRENT.rp is set equal to one and CURRENT is set equal to CURRENT.right as in step 2.3 of the pseudocode. If instead, in decision block 530, the current revenue is not greater than CURRENT.rev, then CURRENT.rp is set equal to one and CURRENT is set equal to CURRENT.right as in 538.

In 534, if CURRENT.lp is equal to one, then CURRENT is set equal to CURRENT.right and in 526 the solutions are reported. The solutions can be shown in graphical form or in other forms that are suitable for analysis. The solutions can be stored for later analysis or can be sent to other sites for analysis. After 534, the routine moves back to decision step 508. The above routine performs a binary search in order to find the smallest number of lambda values necessary to produce the largest number of unique solutions which yields a dense tradeoff curve of portfolio size versus revenue coverage.

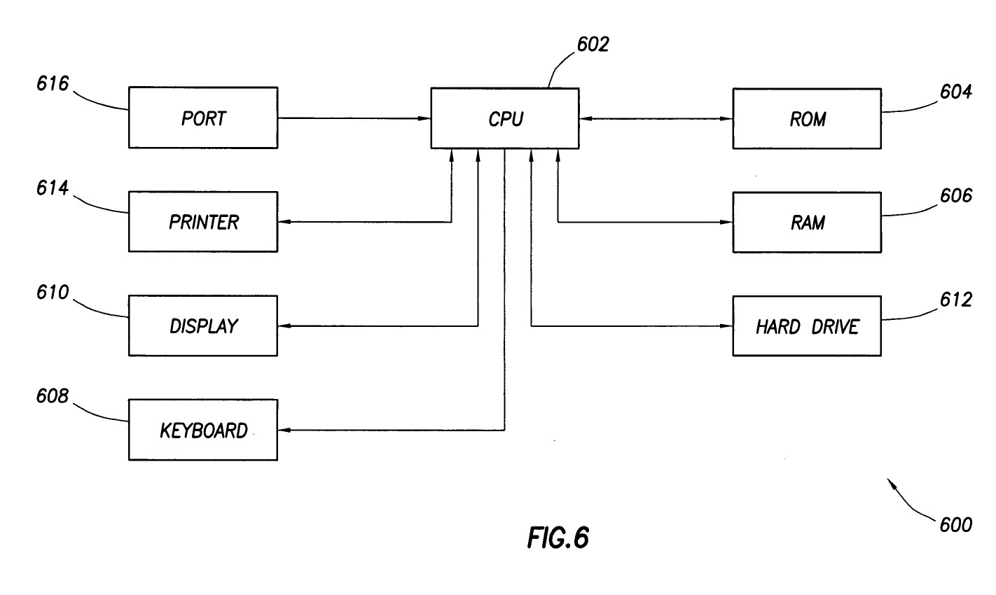

Referring now to FIG. 6, there is shown a computer system that can implement the method described above. The computer system 600 includes a central processing unit (CPU) 602, Read Only Memory (ROM) 604, Random Access Memory (RAM) 606, keyboard 608 for inputting information, display 610, non-volatile storage 612 (e.g., a hard drive), and a printer 614. The method described herein can be embodied in executable code stored on a storage medium such as the hard drive 612. The computer system 600 allows the revenue coverage optimization executable code to be executed on the CPU 602 with the results being stored on the hard drive 612 or other storage location. Historical product order data and order revenue data that are used in determining the products for the product portfolio can be received by input/output (I/O) port 616. I/O 616 can comprise an Ethernet, serial, parallel, or any other type of port. I/O port 616 receives the product order data and the order revenue data can be stored in servers or other data storage devices that are coupled via a network, such as a local area network (not shown) to computer system 600. In another embodiment where the hard drive 612 has stored therein the historical product order and order revenue data, then the CPU 602 can receive the data from the hard drive 612. The results can also be shown graphically on display 610 and/or printed using printer 614. The computer system 600 can be coupled to other computer systems via port 616. Results from computer system 600 can be sent to other systems (e.g., server or remote computer) via the port 616 and results stored at a remote site or locally on hard drive 612.

The above discussion is meant to be illustrative of the principles and various embodiments of the present invention. Numerous variations and modifications will become apparent to those skilled in the art. It is intended that the following claims be interpreted to embrace all such variations and modifications.

What is claimed is:

1. A method for product portfolio analysis, comprising:
identifying a set of customer orders including a set of ordered products, a total order benefit and a penalty multiplier;
identifying one or more subsets of the ordered products each having a subset order benefit and a penalty multiplier; and
selecting one or more of the penalty multipliers using a binary search in order to determine order benefit coverage as a function of a number of ordered products selected.

2. A method for product portfolio analysis as defined in 1, wherein the total order benefit and the subset order benefit for each of the one or more subsets of the ordered products is selected from among revenue, profit and number of products in the ordered product subset.

3. A method for product portfolio analysis as defined in claim 1, wherein the penalty multiplier for each of the one or more subsets of ordered products is determined by dividing the subset order benefit by the number of order products in the subset.

4. A method for product portfolio analysis as defined in claim 1, wherein the binary search includes determining an upper envelope of a set of graph lines of the set of ordered products and the one or more subsets of ordered products.

5. A method for product portfolio analysis as defined in claim 4, wherein the set of graph lines are generated by subtracting from the order benefit the penalty multiplier times the number of products for the set of ordered products and each of the one or more subsets of ordered products.

6. A method for product portfolio analysis as defined in claim 1, wherein the selecting yields a minimum number of penalty multipliers.

7. A method for product portfolio analysis as defined in claim 6, wherein the penalty multipliers (λ) are determined by solving a linear function fₒ (λ)=Rₒ−λ|Pₒ| for λ, where Pₒ is the set of products in all orders in O, and Rₒ is the revenue in all orders in O.

8. A method for selecting products for a product portfolio, comprising:
identifying a set of customer orders including a set of ordered products, a total order benefit and a penalty multiplier;
identifying one or more subsets of the ordered products each having a subset order benefit and a penalty multiplier;
generating a linear function for each of the one or more subsets of ordered products, the linear function for each subset is generated by subtracting from each subset order benefit the penalty multiplier for the subset multiplied by the number products in the subset;
finding the one or more subsets of ordered products which form part of an upper envelope for the linear functions generated; and
selecting the products in the one or more subsets that form part of the upper envelope for the product portfolio.

9. A method as defined in claim 8, wherein finding the one or more subsets of ordered products which form part of the upper envelope comprises performing a binary search that uses the penalty multiplier for each of the one or more subsets to determine if each of the one or more subsets forms part of the upper envelope.

10. A method as defined in claim 8, wherein the order benefit for each of the one or more subsets is selected from among revenue, profit and number of products in the ordered product subset.

11. A method as defined in claim 9, wherein the binary search is performed between a first and second boundaries, the first boundary is a solution with no products and the second boundary is a solution with all the products in the set of customer orders.

12. An apparatus that uses order data for a plurality of historical orders in order to select a product portfolio, the order data including each product contained in each of the historical orders and an order benefit for each of the historical orders, the apparatus comprising:
a processor that receives the order data and performs a binary search on the order data in order to generate a series of solutions along an efficient frontier of order benefit coverage versus number of ordered products selected.

13. An apparatus as defined in claim 12, wherein the processor selects a product portfolio that maximizes the revenue of orders covered by the product portfolio.

14. An apparatus as defined in claim 12, wherein the processor determines a penalty multiplier for a number of subsets of ordered products by solving a linear function fₒ (λ)=Rₒ−λ|Pₒ| for λ, where Pₒ is the set of products in all orders in O, Rₒ is the revenue in all orders in O and λ is a nonnegative number.

15. An apparatus as defined in claim 12, wherein the apparatus comprises a computer.

16. An apparatus as defined in claim 12, wherein the processor determines the penalty multiplier by performing a binary search.

17. Application instructions on a computer-usable medium where the instructions, when executed, effect the selection of products:
identifying a set of customer orders including a set of ordered products, a total order benefit and a penalty multiplier;
identifying one or more subsets of the ordered products each having a subset order benefit and a penalty multiplier;
generating a linear function for each of the one or more subsets of ordered products, the linear function for each subset is generated by subtracting from each subset order benefit the penalty multiplier for the subset multiplied by the number products in the subset;
finding the one or more subsets of ordered products which form part of an upper envelope for the linear functions generated; and
selecting the products in the one or more subsets that form part of the upper envelope for the product portfolio

18. Application instructions on a computer-usable medium as defined in claim 17, wherein finding the one or more subsets of ordered products which form part of the upper envelope comprises performing a binary search that uses the penalty multiplier for each of the one or more subsets to determine if each of the one or more subsets forms part of the upper envelope.

19. Application instructions on a computer-usable medium as defined in claim 18, further comprising:
performing the binary search between a first and second boundaries, the first boundary is a solution with no products and the second boundary is a solution with all the products in the set of customer orders.

20. An apparatus for selecting products that are to be included in a product portfolio, comprising:
means for receiving historical order data including products contained in each of the orders as well as revenue data for the historical orders; and
means for taking the historical order data and performing a linear programming relaxation that includes a penalty multiplier for products included in the product portfolio in order to yield a nested series of product portfolios.

21. An apparatus as defined in claim 20, further comprising:
means for determining the penalty multiplier by performing a binary search.
